(19) United States
(12) Patent Application Publication
(10) Pub. No.: US 2011/0316343 A1
(43) Pub. Date: Dec. 29, 2011

(54) PHOTOVOLTAIC MODULE WITH INTEGRATED DIAGNOSTICS

(75) Inventors: Ranier Krauser, Kostheim (GE); Lawrence A. Clevenger, Austin, TX (US); Kevin Prettyman, Austin, TX (US); Brian Christopher Sapp, Austin, TX (US); Kevin S. Petrarca, Austin, TX (US); Harold John Hovel, Austin, TX (US); Gerd Pfeiffer, Austin, TX (US); Zhengwen Li, Austin, TX (US); Carl John Radens, Austin, TX (US)

(73) Assignee: INTERNATIONAL BUSINESS MACHINES CORPORATION, Armonk, NY (US)

(21) Appl. No.: 13/154,037

(22) Filed: Jun. 6, 2011

(30) Foreign Application Priority Data
Jun. 25, 2010 (DE) EP10167287

(51) Int. Cl. H02J 1/00

(52) U.S. Cl. 307/77

(57) ABSTRACT

A photovoltaic module (10) comprises a plurality of solar cells (20) interconnected in serial arrays (15). At least some of the solar cells (20) are equipped with control units (30) comprising at least one thermal sensor (42) and one power sensor (43). The control unit (30) comprises means (35) for removing a specific solar cell (20′) from the photovoltaic module (10) network if said solar cell (20′) is found to have reached a predefined level of degradation. In a preferred embodiment, control unit (30) is an ASIC chip (40) in thermal contact with said solar cell (20) and electrically connected to said solar cell (20).

### FIELD OF THE INVENTION

The invention relates generally to photovoltaic modules in which a plurality of solar cells are electrically interconnected. Specifically, the invention relates to a photovoltaic module in which at least some of the solar cells are equipped with a control unit for diagnosing and/or controlling the module's performance at cell level.

### BACKGROUND OF THE INVENTION

Photovoltaic modules for converting solar energy to electrical energy generally are made up of a set of solar cells that are mounted on a common base and are electrically interconnected. In order to enable convenient installation and servicing of these photovoltaic modules, these modules should be provided with diagnostic features that permit identifying under-performance or malfunction of the module without the need of disconnecting or disassembling any part of these modules.

At present, photovoltaic modules contain no real time and online feedback capability for reporting on whether individual solar cells within the module are degrading or are already defective. While power diagnosis means on the global (i.e. module) level are commonplace, real-time power monitoring with the highest granularity, i.e. at solar cell level, is not generally available. Moreover, it is desirable to integrate additional features, such as an ability to quickly react in case of failure, malfunction or shadowing of individual solar cells within the photovoltaic module. This is becoming more important as high end solar cells with higher power yields are being used.

US 2004/0211456 A1 discloses a monitoring system for evaluating the performance of a photovoltaic module that comprises a plurality of solar cells. The monitoring system includes a separate diagnostic circuit for each of the individual solar cells that may be used for independently diagnosing the functioning of the individual solar cells. The diagnostic circuit includes means for detecting the cell's voltage condition; moreover, the diagnostic circuit may include means for transmitting data on the cell's performance to an external data-analyzing unit in which the data is analyzed in order to identify defective or underperforming solar cells.

US 2009/0145480 A1 discloses a method of tracking power and temperature generated by a solar cell using an electronic circuit connected to the solar cell. The solar cell is equipped with an electronic module that produces control signals indicative of electrical power being generated by the solar cell. The electronic module performs maximum power tracking by varying current or voltage output of the solar cell, thus increasing local maximal electrical power.

WO 2005/005930 A1 discloses an integrated circuit with an embedded condition monitor, a memory for storing the sensed data and a means for communication of the sensed data to an external device.

While the monitoring systems described above enable power monitoring of a photovoltaic module at cell level, they are not capable of automatically initiating maintenance actions if a given cell has reached a predefined level of degradation.

### SUMMARY OF THE INVENTION

It is an object of the invention to provide a photovoltaic module with a monitoring system that enables power, as well as temperature, monitoring at cell level and initiates maintenance actions if a cell has reached a predefined level of degradation.

These objects are achieved by the features of the independent claims. The other claims and the specification disclose advantageous embodiments of the invention.

According to the invention, a photovoltaic module comprising a plurality of interconnected solar cells is provided such that at least some of the solar cells are equipped with a control unit comprising at least one thermal sensor and one power sensor, as well as means for removing a specific solar cell from the photovoltaic module network if said solar cell is found to have reached a predefined level of degradation.

Preferably, the control unit is embodied as a dedicated ASIC attached to a back surface of the solar cell with a thermal paste so that good thermal contact between the solar cell to be monitored and the control unit containing the thermal sensor is ensured. In a preferred embodiment, a transmission circuit for transferring signals issued from said sensors to a collector unit of the photovoltaic module is provided; preferably, solar cell control unit comprises an RF unit for enabling wireless communication between solar cell control unit and the collector unit of the photovoltaic module.

### BRIEF DESCRIPTION OF THE DRAWINGS

The present invention, together with the above-mentioned and other objects and advantages, may best be understood from the following detailed description of the embodiments, but not restricted to the embodiments, wherein is shown in:

FIG. 1 a schematic plan view of a photovoltaic module with a plurality of solar cells;

FIG. 2 a schematic circuit diagram of a plurality of solar cells arranged in a serial array, each solar cell being equipped with a control unit;

FIG. 3 a schematic plan view of a solar cell equipped with a control unit embodied as a control unit chip attached to the solar cell's back surface;

FIG. 4 a schematic circuit diagram of control unit chip of FIG. 3; and

FIG. 5 a schematic circuit diagram of a plurality of solar cells arranged in a serial array, with every other solar cell being equipped with a control unit.

In the drawings, like elements are referred to with equal reference numerals. The drawings are merely schematic representations, not intended to portray specific parameters of the invention. Moreover, the drawings are intended to depict only typical embodiments of the invention and, therefore, should not be considered as limiting the scope of the invention.

### DETAILED DESCRIPTION OF EXAMPLE EMBODIMENTS

FIG. 1 shows a schematic view of a photovoltaic module 10 containing a multitude of electrically interconnected solar cells 20. The function of the solar cells 20 is to convert solar energy to electricity and each solar cell 20 has a front surface 28 that receives the solar energy. The cells 20 may be connected in a series to achieve a desired output voltage and/or in parallel to provide a desired amount of current source capability. In the embodiment of FIG. 1, cells 20 are connected in a series to form strings 15 that are in turn connected in parallel to form photovoltaic module 10.

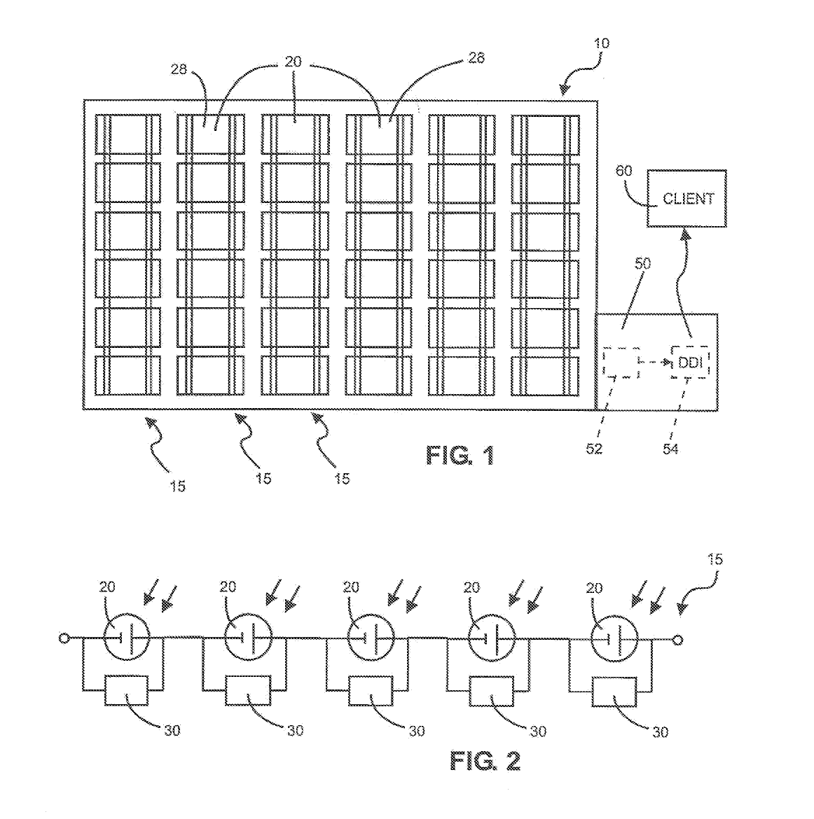

FIG. 2 shows a circuit diagram of a string 15 of solar cells 20 connected in a serial arrangement. In a first preferred embodiment of the invention, each solar cell 20 is provided with a dedicated control unit 30 that is connected in parallel with this particular solar cell 20. Dedicated control unit 30 enables monitoring of solar cell 20, as well as performing control functions on solar cell 20.

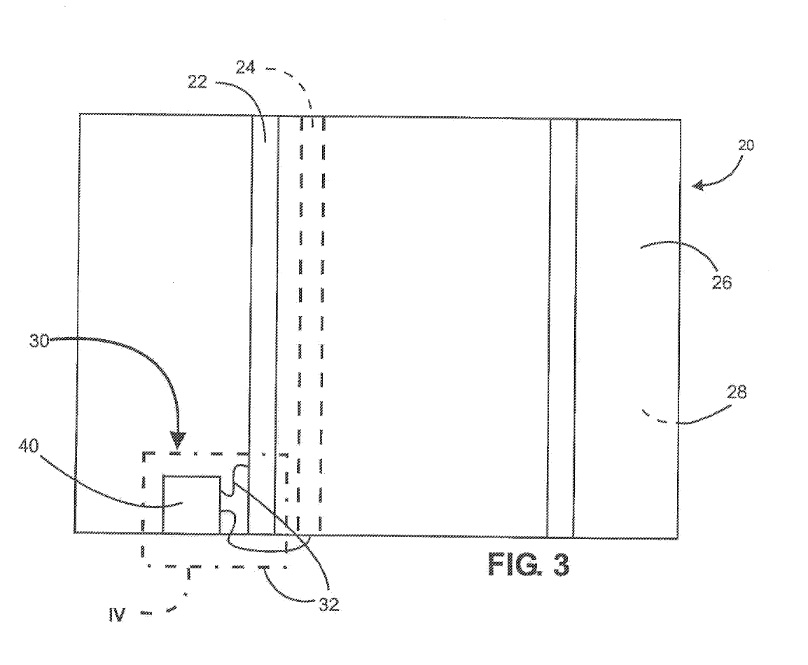

FIG. 3 depicts a detailed plan view of a back surface 26 of one of the solar cells 20 in a serial string 15. Control unit 30 of solar cell 20 is embodied as an ASIC 40 that is attached to the solar cell's 20 back surface 26. Specifically, the control unit chip 40 may be fixed to the solar cell's alumina backside surface 26 using an adhesive with high thermal conductivity or a thermal contact paste so that control unit chip 40 is in good thermal contact with solar cell 20. This enables direct temperature measurement using a thermal sensor 42 integrated into control unit 30. In the embodiment of FIG. 3, control unit chip 40 is located in direct proximity of a bus bar 22 on solar cell 20 back surface 26 and is electrically connected to the bus bars 22, 24 of solar cell back and front surfaces 26, 28 using wire bond 32.

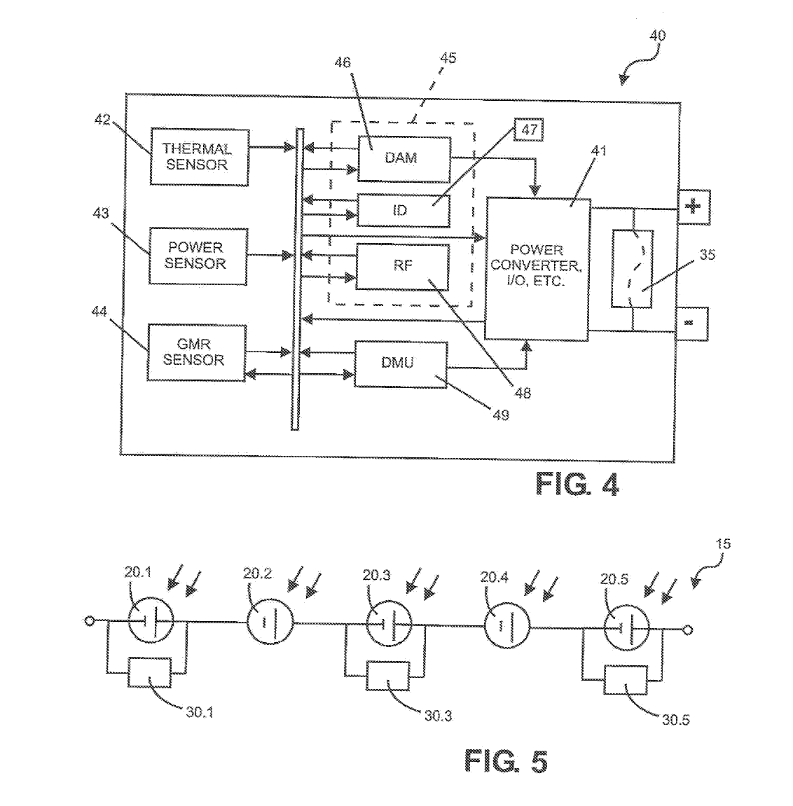

FIG. 4 shows a schematic layout of ASIC embodiment 40 of control unit 30 with sub-circuits (function blocks) for identification, measurement and transmission. Control unit chip 40 is electrically connected to the electrical circuit 22, 24 of solar cell 20 via a power converter and an I/O device 41. Control unit chip 40 is battery buffered and the chip's batteries are loaded during solar cell operation throughout the day. Thus, only two (2) connections are required to interconnect control unit chip 40 to the solar cell's power lines 22, 24.

Control unit chip 40, FIG. 2, contains a variety of sensors, such as a thermal sensor 42, a power sensor 43 and a GMR (giant magnetic resonance) sensor 44. Through the embedded GMR sensor 44 (or Hall sensor) in the ASIC chip 40, the cell or string current can be determined via a magnetic field measurement. A transmission circuit 46 integrated into control unit chip 40 transmits data acquired by the sensors 42, 43 and 44 to a collector unit 50 of photovoltaic module 10 (FIG. 1). Transmission circuit 45 comprises a modulator 46 that transforms output signals issued by the sensors 42, 43 and 44 into an appropriate format for physical transmission to a demodulator 52 located in collector unit 50 that collects signals issued from various solar cells 20 contained in photovoltaic module 10. An identification circuit 47 attaches a unique digital identification number that allows signals sent to collector unit 50 to be tracked back to the specific solar cell 20 they originate from. Transmission circuit 46 may comprise an RF (radio frequency) unit 48 for enabling wireless communication between control unit chip 40 of solar cell 20 and a collector unit 50 of photovoltaic module 10.

A data management unit (DMU) 49 comprises means for controlling data transfer from sensors 42, 43 and 44 to transmission circuit 46. Data management unit 49 may also comprise additional features, such as a logical unit to be used for diagnostics and (pre-) evaluation of the sensor signals and/or memory for storing measured data, threshold data and/or software for performing diagnostics. In order to allow signals from multiple sensors 42, 43 and 44 to be transmitted to collector unit 50 in an orderly fashion, data management unit 49 contains a multiplexer that is used to switch between the signals issued by the various sensors 42, 43 and 44 of control unit chip 40.

Control unit chip 40 may also include hardware features such as bypass diodes and/or switches 35, which may, for example, be used to short-circuit solar cell 20 in the case that measured temperature and/or power data acquired by sensors 42, 43 on solar cell 20 exceed or fall below a predetermined threshold value, indicating that solar cell 20 may be shaded or defective.

If a solar cell 20 within photovoltaic module 10 fails, this has an impact on the module's performance. If a solar cell 20′ within a serial array 15 with other solar cells 20 (such as the one depicted in FIG. 2) fails, this defective cell 20′ acts as a current trap and causes the current through string 15 to sag. If this occurs, it is preferable to short-circuit defective solar cell 20′ so that—while the total voltage of the overall string 15 will be reduced by the voltage of the defective cell 20′—the overall current will not diminish. As described above, control unit chip 40 may comprise means (diodes and/or switches 35) to short-circuit a given solar cell 20 temporarily or permanently. In a preferred embodiment, switch 35 is directly coupled to thermal sensor 42 so that switch 35 is closed if the temperature of solar cell 20 thermally coupled to control unit 40 exceeds a predetermined threshold temperature; by closing switch 35, solar cell 20 is short-circuited and, thus, removed from the serial array 15 of solar cell 20.

Note that in the preferred embodiment of FIG. 4, no additional wiring (besides wires 32 connecting control unit chip 40 to solar cell bus bars 22, 24) is required for communicating measurement data collected by sensors 42, 43 and 44 to collector unit 50, since control unit chip 40 uses an RF unit 48 for wireless transmission of cell performance information to the collector unit 50 on the module level. In order to allow control units 30 belonging to different solar cells 20, 20′ within photovoltaic module 10 to use the same RF channel, a time domain multiple access (TDMA) scheme may be used for data transmission. All output signals originating from solar cell 20′ are coded using identification circuit 47 so as to individually identify the control unit 30′ (and the solar cell 20′) from which they were issued. Thus, all transmitted measured data and information about cell performance can be tracked back to a specific control unit 40′ and to the specific solar cell 20′ it is attached to.

The signals collected by the sensors 42, 43 and 44 of control unit chip 40 provide information on the present operational status of the specific solar cell 20 that the control unit chip 40 is attached to. Signals issued from the various control units 30, 30′ of solar cells 20, 20′ within the photovoltaic module 10 are collected by collector unit 50 of photovoltaic module 10 that comprises a data acquisition and RF (de)modulating device 52 connected to a demodulation and data acquisition interface (DDI) 54.

Besides data acquisition and demodulation, the collector unit 50 of photovoltaic module 10 may comprise a multitude of additional functions, such as temperature and power sensors, a multiplexer for switching between inputs from the various solar cells 20, 20′ etc. Preferably, collector unit 50 of photovoltaic unit 10 is embodied as an ASIC chip that is physically identical to control unit 40 of the individual solar cells 20, so that only one single type of ASIC is required.

Data acquisition interface 54 may create records based on sensor data from one or several control units 30, 30′. Measurement data to be used for solar cell performance diagnostics is available in real time for on-line malfunction detection and prevention. Data acquisition interface 54 may comprise means for transmitting data (e.g. via internet) to a client 60 (which may be located far away from photovoltaic module 10) where the data is evaluated. The communication via Internet enables a long-distance online management of photovoltaic module 10 down to the solar cell 20 level. For example, temperature data collected on various solar cells 20, 20′ of photovoltaic module 10 may be evaluated to decide whether cooling and/or IR or UV protection must be provided to the photovoltaic module and/or whether maintenance is required. Power output feedback on the cell level, as well as on the module level yields information on which one of the solar cells 20, 20′ requires maintenance or repair. Thus, by integrating control units 30 into individual solar cells 20 in photovoltaic module 10, the operational management of the photovoltaic module 10 may be improved both on the local and the global levels. It has been found that an operational management concept, such as the one outlined above, may improve module performance by up to 10%.

In the embodiment of FIG. 3, the temperature of solar cell 20 is measured in a small region on the back surface 26 of solar cell 20 (namely the area in which control unit chip 40 is attached to solar cell back surface 26). Assuming good thermal contact between surface 26 and chip 40, as well as a reasonable resolution (±0.5° C.) of temperature measurement, thermal sensor 42 will furnish accurate and actual information on whether solar cell 20 heats up locally. In order to obtain a global temperature measurement of solar cell 20, thermal sensor 42 may be designed in such a way as to cover the entire back surface 26 of solar cell 20 (it may, for example, be screen printed onto this back surface 26).

Note that power measurement on a given solar cell 20 in itself is not sufficient for determining the performance of that solar cell 20. Rather, an estimate of the cell's temperature is also needed. In the case of defects within the solar cell 20 (like hot spots or diode-like shunts), the current increases locally and leads to a heating of the solar cell 20. Thus, a combination of power and temperature measurement is much more reliable to determine the actual solar cell performance. If a given solar cell 20′ within a serial string 15 of solar cells 20 deteriorates, other cells 20 in the string 15 will pump energy into the failing cell 20′ that leads to an additional increase in that defective cell's 20′ temperature. Therefore, a monitoring setup must be able to measure the cell's temperature and will, preferentially, also yield information on electrical power as well as polarity. Collector unit 50 of the photovoltaic module 10 can be used to measure dark current during a diagnosis cycle at night.

Based on the sensor data furnished by control units 30 of the individual solar cells 20 within photovoltaic module 10, usage, performance, etc., of the photovoltaic module 10 can be monitored down to cell level as a function of time and these data can be used as a basis for decisions on operation and maintenance. Data from solar panels comprising a multitude of photovoltaic modules 10 may be consolidated in a central client control station 60 and used for a variety of decisions, such as weather protection, cleaning, replacement, etc., of photovoltaic modules 10. The embedded control units 30, thus, enable real-time diagnostics and performance prediction down to the cell level, as well as a wide variety of other advanced analysis capabilities.

Note that it is not necessary to provide a control unit 30 to each single solar cell 20 within photovoltaic module 10. Rather, for most applications it is adequate to integrate a control unit into every other solar cell 20 within a serial string 15, so that the number of control units 30 required for performance management of photovoltaic module 10 may be cut in half.

FIG. 5 shows an embodiment of a string 15′ of solar cells 20.1 to 20.5 such that only every other cell 20.1, 20.3 and 20.5 is equipped with an embedded control unit 30.1, 30.3, 30.5.

The performance of a solar cell 20.2 that is not equipped with a control unit of its own has to be calculated from the sensor data provided by its neighboring cells 20.1 and 20.3 in string 15′. Specifically, power output P₂ of solar cell 20.2 can be determined using electrical data collected from its neighbors 20.1 and 20.3 in the following way:
Since total voltage Uₜₒₜ=□Uᵢ, voltage of solar cell 20.2 may be calculated from the voltages U₁, U₃ measured at neighboring cells 20.1 and 20.3 by U₂=U₁ₜₒ₃−U₁−U₃. Analogously, resistance Rₜₒₜ=□Rᵢ, and, thus, resistance of solar cell 20.2 is R₂=R₁ₜₒ₃−R₁−R₃. Since power Pₜₒₜ=Uₜₒₜ²/Rₜₒₜ, power of solar cell 20.1 may be calculated as P₂=U₂²/R₂, and efficiency η₂ of solar cell 20.2 can be calculated as η₂=P₂/A₂, where A₂ is the area of solar cell 20.2.

The temperature T₂ of solar cell 20.2 can be estimated using the sensor data of thermal sensors 42 within control units 30.1 and 30.3 located on neighbor cells 20.1 and 20.3 by assuming temperature T₂ to be the mean of the neighbor cell temperatures (T₂=[T₁+T₃]/2). If solar cell 20.2 displays a smaller power output even though its illumination level is comparable to its neighboring cells 20.1 and 20.3, this reduction in power output will typically be due to an elevated temperature of this cell 20.2. This effect is most likely due to a presence of shunts within the material structure of this cell 20.2 that causes an increased local current due to a higher level of recombination; this current, in turn, affects a heating of the solar cell 20.2. In order to allow for this affect, a temperature correction factor κ₂ is introduced based on the respective solar cell's 20.2 power output: T₂′=κ₂*[T₁+T₃]/2, where κ₂ is estimated from κ₂=Pₜₒₜ/P₂. Thus, the lower the output power of solar cell 20.2, the higher the correction factor κ₂ for that solar cell 20.2 and the higher the temperature of that solar cell 20.2. An accurate estimate of the temperature of solar cell 20.2 possessing no control unit of its own can thus be determined from an average of the temperatures of neighbor cells 20.1, 20.3 and the temperature correction factor κ₂.

Due to the fact that control units 30.1, 30.3 and 30.5 in every other solar cell 20.1, 20.3 and 20.5 in serial array 15′ delivers complete information on this cell's performance, the power yield, as well as the efficiency of in-between cells 20.2, 20.4 without control units can be calculated from the electrical data of their neighbor cells.

1. A photovoltaic module comprising:
a plurality of interconnected solar cells, a set of said solar cells including a control unit comprising:
at least one thermal sensor;
at least one power sensor; and
apparatus for removing a specific power cell when said specific power cell has reached a predetermined level of degradation.

2. The photovoltaic module of claim 1, wherein said control unit is an application specific integrated circuit chip (ASIC).

3. The photovoltaic module of claim 2, wherein said ASIC is attached to the back surface of said solar cell.

4. The photovoltaic module of claim 3, wherein said ASIC is attached to the back surface of said solar cell by a thermal paste.

5. The photovoltaic module of claim 3, wherein:
a plurality of said solar cells are connected in series with each other; and
said control unit chip is connected in parallel across the solar cell.

6. The photovoltaic module of claim 5, further including:
a bus bar on the back surface of said solar cell connected to said control unit chip; and
a bus bar on the front surface of said solar cell connected to said control unit chip.

7. The photovoltaic module of claim 2, wherein said control unit chip further includes a magnetic sensor for monitoring magnetic properties of said solar cell.

8. The photovoltaic module of claim 7, wherein said control unit chip further includes:
a collector unit; and
a transmission circuit for transmitting signals from sensors to said collector unit.

9. The photovoltaic module of claim 7 further including:
a collector unit; and
wherein said control unit chip further includes an RF unit enabling wireless communication between said control unit chip and said collector unit.

10. The photovoltaic module of claim 1 further including apparatus for short circuiting selected solar cells.

11. The photovoltaic module of claim 10, wherein said apparatus activates said short circuiting when the temperature of a solar cell exceeds a predetermined threshold.
